(19) United States
(12) Patent Application Publication
(10) Pub. No.: US 2023/0192171 A1
(43) Pub. Date: Jun. 22, 2023

(54) Digital Automobile Steering Wheel

(71) Applicant: Mordchay Dirnfeld, Fort Lee, NJ (US)

(72) Inventor: Mordchay Dirnfeld, Fort Lee, NJ (US)

(21) Appl. No.: 17/552,388

(22) Filed: Dec. 16, 2021

(51) Int. Cl. B62D 1/04; B62D 15/02; B62D 5/00

(52) U.S. Cl. CPC B62D 1/046; B62D 15/029; B62D 5/006; G06V 40/166

(57) ABSTRACT

An article of manufacture for providing a digital automobile steering wheel according to the present invention includes a rotating steering wheel for providing directional for directing a vehicle when in motion, a video display device coupled to a center of the rotating steering wheel configured to be visible to a driver when operating the rotating steering wheel, a camera for obtaining an image of a face of the driver, a fingerprint scanner for obtaining a fingerprint scan of a finger of the driver, and an iris scanner for obtaining an iris scan of an eye of the driver. The digital automobile steering wheel also uses a set of control electronics and processing components, a position communications device for providing a current position of the steering wheel, and a user interface port coupled to one or more steering wheel user input/output devices for receiving input from the driver.

### TECHNICAL FIELD

This application relates in general to an article of manufacture for providing vehicle control devices, and more specifically, to an article of manufacture providing a digital automobile steering wheel.

### BACKGROUND

An automobile steering wheel remains untouched in terms of digital innovation while much of the other controls that operate the vehicle have evolved over time. The current steering wheel functionality needs to be protected as much as possible while adding many convenient features and safety measures that may be implemented using digital technology consisting of sensors, processing functionality, and user interface devices.

Therefore, a need exists for an article of manufacture for providing a digital automobile steering wheel. The present invention attempts to address the limitations and deficiencies in prior solutions according to the principles and example embodiments disclosed herein.

### SUMMARY

In accordance with the present invention, the above and other problems are solved by providing an article of manufacture for a digital automobile steering wheel according to the principles and example embodiments disclosed herein.

In one embodiment, the present invention is an article of manufacture for providing a digital automobile steering wheel including a rotating steering wheel for providing directional for directing a vehicle when in motion, a video display device coupled to a center of the rotating steering wheel configured to be visible to a driver when operating the rotating steering wheel, a camera for obtaining an image of a face of the driver, a fingerprint scanner for obtaining a fingerprint scan of a finger of the driver, and an iris scanner for obtaining an iris scan of an eye of the driver.

In another aspect of the present invention, the digital automobile steering wheel also uses a set of control electronics and processing components, a position communications device for providing a current position of the steering wheel, and a user interface port coupled to one or more steering wheel user input/output devices for receiving input from the driver.

In another aspect of the present invention, the set of control electronics and processing components includes a steering wheel controller, a steering wheel connection, a rotation resistance controller, the user interface port that is coupled to the one or more steering wheel user input/output devices, a FaceID reader coupled to the camera, a fingerprint reader coupled to the fingerprint scanner, and an iris reader coupled to the iris scanner.

In another aspect of the present invention, the rotating steering wheel includes an inner portion, an outer portion coupled to an outer edge of the inner portion, the inner portion rotates about the outer edge, and the position communications device configured between the outer portion and inner portion.

In another aspect of the present invention, the position communications device utilizes two or more optical sensors for detecting the passage of equally spaced position markings as the outer portion rotates about the inner portion.

In another aspect of the present invention, the position communications device utilizes two or more electrical connections for detecting the passage of equally spaced position electrical connections as the outer portion rotates about the inner portion.

In another aspect of the present invention, the rotating steering wheel is removable for utilizing different diameter wheels.

In another aspect of the present invention, the video display device continually presents an upright image as the rotating steering wheel rotates.

In another aspect of the present invention, the rotation resistance controller generates rotational resistance commands based upon a current position of the rotating steering wheel from the position communications device and haptic data commands from the steering wheel controller as the vehicle is being driven.

In another aspect of the present invention, the rotational resistance commands generated by the rotation resistance controller are transmitted to the rotating steering wheel over the steering wheel connection for adjusting an amount of rotational resistance should be applied by the rotating steering wheel to adjust the ease at which the driver may rotate the rotating steering wheel.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIG. 1 illustrates an example embodiment of an article of manufacture providing a digital automobile steering wheel according to the present invention.

FIGS. 2a-b illustrate a close-up view of an article of manufacture providing a digital automobile steering wheel according to the present invention.

FIG. 3 illustrates a block diagram of the components of an article of manufacture providing a digital automobile steering wheel according to the present invention.

FIG. 4 illustrates a computing system of software components for providing olfactory sensory stimulation according to the present invention.

FIGS. 5a-b illustrate generalized schematics of a programmable processing system utilized as the various computing components described herein used to implement an embodiment of the present invention.

### DETAILED DESCRIPTION

This application relates in general to an article of manufacture for providing vehicle control devices, and more specifically, to an article of manufacture providing a digital automobile steering wheel according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

The terms “individual” and “user” refer to an entity, e.g., a human, using an article of manufacture providing a digital automobile steering wheel according to the present invention. The term user herein refers to one or more users.

The term “invention” or “present invention” refers to the invention being applied for via the patent application with the title “Digital Automobile Steering Wheel.” Invention may be used interchangeably with steering wheel.

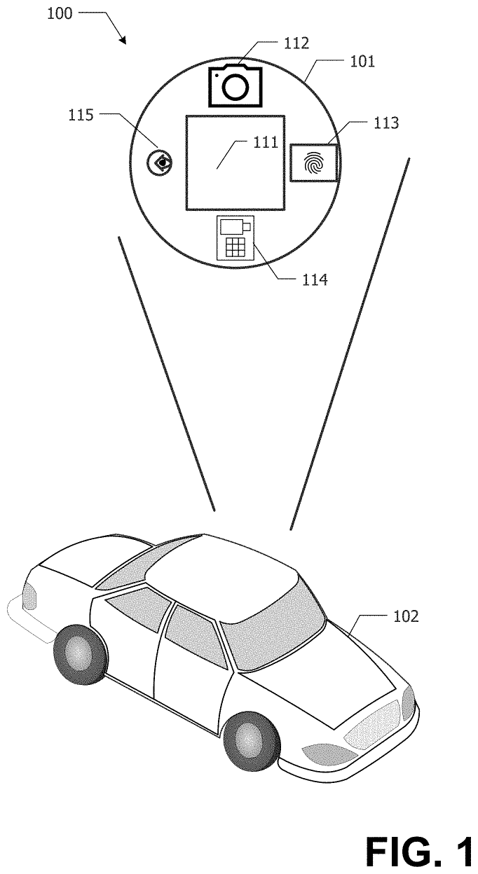

In general, the present disclosure relates to an article of manufacture providing a digital automobile steering wheel according to the present invention. To better understand the present invention, FIG. 1 illustrates an example embodiment of an article of manufacture providing a digital automobile steering wheel according to the present invention. Traditionally, the steering wheel is attached to the vehicle 102 at the center with spokes to the outer part of the steering wheel. The present invention 100 attaches the steering wheel to the vehicle 102 from the actual wheel where drivers grab on to hold the device. Additionally, a video display device 111, a camera 112, a fingerprint scanner 113, an input device such as a keypad or set of input switches 114, and an iris scanner 115 may be added to the steering wheel 100.

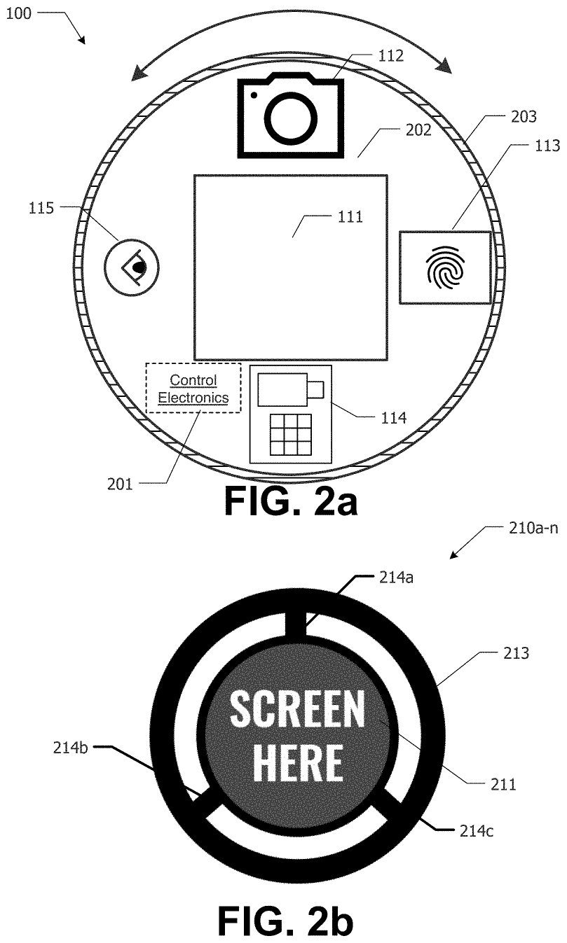

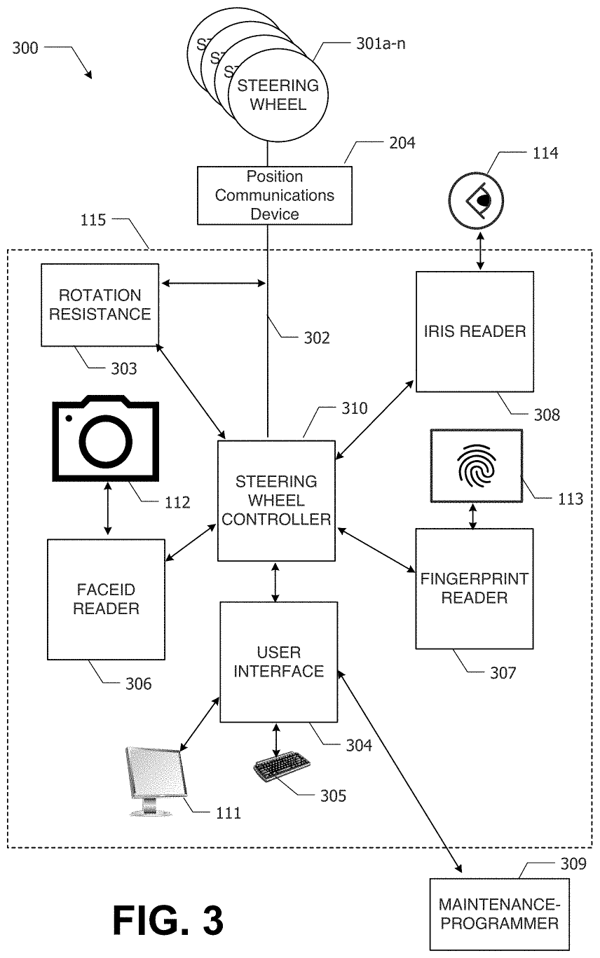

Adding these user interface components to the steering wheel 100 allows the driver to interact with the vehicle 102 using new, improved, and additional features, functions, and safety controls. These new features, functions, and safety controls may be provided by control electronics and processing components 201 described in more detail in reference to FIGS. 2-3 below.

FIGS. 2a-b illustrate a close-up view of an article of manufacture providing a digital automobile steering wheel according to the present invention. In a preferred embodiment, the video display device 111 would remain stationary with the image continually positioned in an upward orientation. In such an embodiment, the steering wheel 100 comprises an outer portion 203 and inner portion 202 of the center of the steering wheel 100. The outer portion 203 may rotate about the inner portion 202 to provide input from the driver regarding a desired orientation of the vehicle wheels. The outer portion 203 may be coupled to the inner portion 202 about its outer edge and being configured to move about the outer edge while providing position input to the control electronics and processing components 201.

The outer portion 203 may be held within a containing slot through which it may move. An inner edge of the outer portion may have a position communications device 204 to electrically generate position data for the control electronics and processing components 201. The position communications device 204 may include an optical sensor that detects passage of position markings along the inner edge of the outer portion 203; for example, a sequence of equally spaced markings along the inner edge of the outer portion 203 may be detected and counted to determine the amount of rotation of the outer portion 203 that has occurred. By detecting the direction of the equally spaced markings using two or more optical sensors positioned about each other by detecting which of the two or more optical sensors observes the position of the equally spaced markings is observed first. Similar position data may be generated electrically by detecting when the equally spaced markings include electrical connections that engage contacts of the inner portion 202 as the outer portion 203 rotates. Other possible position encoding and detection mechanisms may be used.

FIG. 2b shows an alternate embodiment in which the steering wheel 210a-n having a center portion 211 of the steering wheel 210a-n connected to an outer ring 213 connected to the spokes 214a-c and actual car (not shown). The video display device 111 may be positioned over the center portion 211. In this alternate embodiment, the spokes 214a-c are connected to the car and the steering wheel 210a-n be an interchangeable part having different diameters. The steering wheel 210a-n may rotate about the spokes 214a-c with the position communications device 204 being locates along the spokes 214a-c as the steering wheel 210a-n rotates. In a final possible embodiment. the entire steering wheel 210a-n may rotate as normal but have control electronics and processing components 201 counter rotate the image on the video display device 111, and as such appearing to remain stationary.

As disclosed above in reference to FIG. 1, the digital steering wheel 100 may include the video display device 111, the camera 112, the fingerprint scanner 113, the input device such as a keypad or set of input switches 114, and the iris scanner 115. A set of control electronics 115 contained within the structure of the steering wheel 100 interacts with these components to operate the vehicle 102.

The video display device 111 provides a user display device that provides information regarding the vehicle 102 as well as input controls if the video display device 111 is also a touchscreen device. The video display device 111 may control an audio system, an environmental control system, cellphone integration, and similar driver controls with the touchscreen acting as an input device. The video display device 111 also may present the driver with error and vehicle system failure warning messages. These warning messages may provide significantly more information regarding any particular failure or warning than is currently provided to drivers using a single warning light found on most automobile dashboards.

The camera 112 may be used to capture an image of the driver once seated in the vehicle. Using facial recognition software, any captured image of the driver may be used to identify the driver that enables the vehicle engine to operate. This technology may render the automobile useless until an authorized individual is within the vehicle.

The camera 112 may be positioned about the inner portion 202 of the steering wheel 100 and oriented towards the driver while seated at behind the steering wheel 100. The camera 112 captures the driver and his or her face for use in the identification of the driver. In alternate embodiments, the camera 112 may include additional camera devices pointed forward towards the windshield to collect images while the vehicle is being driven.

The fingerprint scanner 113 may receive a scan of a fingerprint for comparison with a previously entered and trained fingerprint to identify an individual authorized to unlock the vehicle 102 and enable the engine. The fingerprint scanner 113 may be trained using fingerprints from any number of individuals to allow the vehicle 102 to be unlocked. The fingerprint scan generated by the fingerprint scanner 113 may be compared against all previously trained fingerprints to identify a match.

The input device 114 such as a keypad or set of input switches may be included as part of the steering wheel 100 to provide an alternate input mechanism in addition to the fingerprint scanner 113 and iris scanner 115. The input device 114 may be a simple 10 digit keypad or similar set of input devices that permit the driver to provide input to the control electronics 201 as needed. This input device 114 also may be integrated into a touchscreen video display device 111 in the alternative.

The iris scanner 115 may receive a scan of a driver's iris for comparison with a previously entered and trained iris scan to identify an individual authorized to unlock the vehicle 102 and enable the engine. The iris scanner 115 may be trained using iris scans from any number of individuals to allow the vehicle 102 to be unlocked. The iris scan generated by the iris scanner 115 may be compared against all previously trained iris scan images to identify a match.

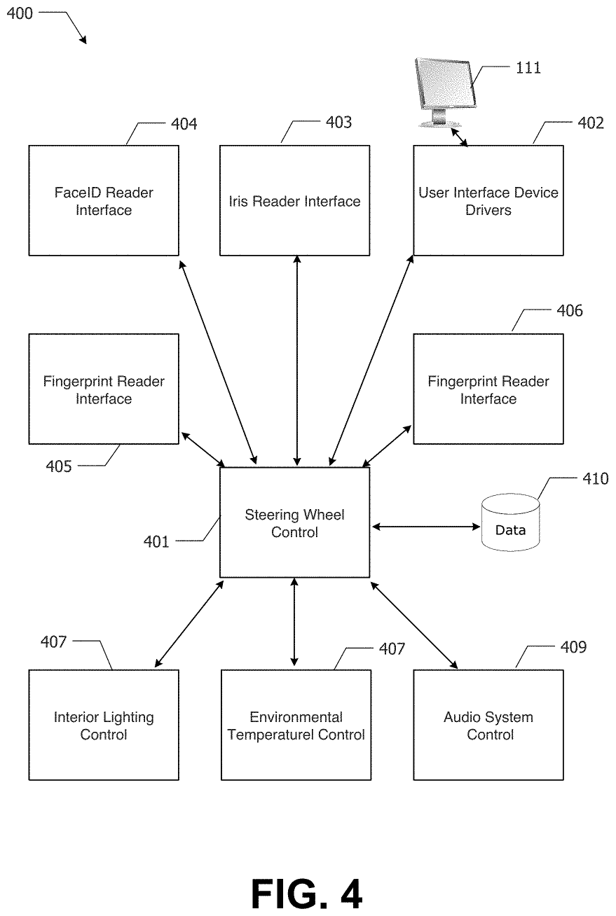

A set of control electronics 201 interact with the steering wheel 100 devices 111-115 to receive inputs from the driver, to provide information to the driver, and to control operations of various systems within the vehicle 102. Details regarding the set of control electronics 201 is described in more detail in reference to FIGS. 3-4 below.

FIG. 3 illustrates a block diagram of the components of an article of manufacture providing a digital automobile steering wheel according to the present invention. An example embodiment of the set of control electronics 300 comprises a steering wheel controller 310, a steering wheel connection 302, a rotation resistance controller 303, a user interface port 304 that is coupled to the steering wheel user input/output devices 305, a FaceID reader 306, a fingerprint reader 307, and an iris reader 308.

A set of steering wheels 301a-n may be interchangeable versions of the steering wheel 100 having different diameter sizes and different sets of steering wheel devices 111-115 to meet the individual needs of different drivers. Each of the individual steering wheels in the set of steering wheel devices 301a-n may be attached and detached from the vehicle by the corresponding driver with the individual steering wheels being connected to the vehicle via a common interface connection port. The set of control electronics 300 for the individual steering wheels 301a-n may be contained therein in one possible embodiment. Such an embodiment would provide the storage of the various FaceID images, fingerprint scans, and iris scans in each steering wheel for further security. In an alternate embodiment, set of control electronics 300 may be in the vehicle 102 itself with the common interface connection port interconnecting the different sets of steering wheel devices 111-115 to the set of control electronics 300 as required.

The steering wheel controller 310 is a programmable computing device that performs instructions to send and receive data with the driver using the different sets of steering wheel devices 111-115. The steering wheel controller 310 also provides commands and control signals to the vehicle 102 including enabling the engine operation, unlocking the vehicle 102, and controlling the operation of the audio, environmental, and lighting controls to operate the vehicle 102. The steering wheel controller 310 also receives data, in the form of error codes, failure and warning codes, and other signals from the vehicle 102 to be provided to the driver. The error codes, failure and warning codes, and other signals may be used by the steering wheel controller 310 to generate video display images and related information for viewing by the driver on the video display device 111. The steering wheel controller 310 processes all driver input commands received from the steering wheel user input/output devices 305 to command appropriate systems in the vehicle to correspond to the driver's input.

The steering wheel connection 302 provides a communications connection between the steering wheel controller 310, the rotation resistance controller 303, the position communications device 204, and the steering wheel elements 301a-n. The position communications device 204 communicates a current position of the steering wheel 100 as driver provides input movement of the steering wheel to the steering wheel controller 310. The steering wheel controller 310 may provide decode the position data to provide commands to the vehicle to direct the car in a desired direction. The steering wheel controller 310 also provides haptic data commands to the rotation resistance controller 303 regarding the haptic feedback to the driver in rotating the steering wheel 100. The rotation resistance controller 303 communicates rotational resistance commands to the steering wheel 310a-n over the steering wheel connection 302 enabling the steering wheel may adjust the haptic reaction of the steering wheel movement to the driver.

The rotation resistance controller 303 generates rotational resistance commands based upon a current position of the steering wheel 301a-n from the position communications device 204 as described above with reference to FIGS. 2a-b and haptic data commands from the steering wheel controller 310 as the vehicle is being driven. The rotation resistance controller 303 determines an amount of rotational resistance should be applied by the steering wheel 301a-n to adjust the ease at which the driver may rotate the steering wheel 100.

The user interface port 304 that is coupled to the steering wheel user input/output devices 305 provides the electrical connections between the user input and output devices, including the video display device 111, the input device 305, and the steering wheel controller 310. The user interface port 304 receives data from the steering wheel controller 310, encodes the data into an image or sequence of images, and transmits these images to the video display device. The user interface port 304 also receives input data from the data input device 305, encodes the data into commands using a format used by the steering wheel controller 310, and transmits the encoded commands to the steering wheel controller 310 for further processing. The user interface port 304 also may receive input data from a touchscreen device that may consist of coordinates on the screen of the display device 111. These coordinates may be transmitted to the steering wheel controller 310 allowing it to determine what the position on the screen corresponds to within the image recently sent to the video display device 111.

The FaceID reader 306 receives driver image data from the camera 112 and processes the driver image data to identify face matchable components from the driver image data. These components, and their corresponding locations within the driver image data, may be matched against one or more previously scanned and trained driver image data for authorized driver(s). The matching processing may occur within the FaceID reader 306 or within the steering wheel controller 310. The previously scanned and trained driver image data may be stored within permanent memory of the FaceID reader 306. The match result or failure is reported to the steering wheel controller 310. In an alternate embodiment, the previously scanned and trained driver image data storage and matching processing may occur within the steering wheel controller 310 after the FaceID reader 306 transmits the identifying face matchable components and corresponding coordinate data to the steering wheel controller 310.

The fingerprint reader 307 receives fingerprint scan data from the fingerprint scanner 113 and processes the fingerprint scan data to identify fingerprint matchable components from the fingerprint scan data. These components, and their corresponding locations within the fingerprint scan data, may be matched against one or more previously scanned and trained fingerprint scan images for authorized driver(s). The matching processing may occur within the fingerprint reader 307 or within the steering wheel controller 310. The previously scanned and trained fingerprint scan data may be stored within permanent memory of the fingerprint reader 306. The match result or failure is reported to the steering wheel controller 310. In an alternate embodiment, the previously scanned and trained fingerprint scan data storage and matching processing may occur within the steering wheel controller 310 after the fingerprint reader 306 transmits the identifying fingerprint matchable components and corresponding coordinate data to the steering wheel controller 310.

The iris reader 308 receives iris scan data from the fingerprint scanner 115 and processes the iris scan data to identify iris matchable components from the iris scan data. These components, and their corresponding locations within the iris scan data, may be matched against one or more previously scanned and trained iris scan images for authorized driver(s). The matching processing may occur within the iris reader 307 or within the steering wheel controller 310. The previously scanned and trained iris scan data may be stored within permanent memory of the iris reader 306. The match result or failure is reported to the steering wheel controller 310. In an alternate embodiment, the previously scanned and trained iris scan data storage and matching processing may occur within the steering wheel controller 310 after the iris reader 306 transmits the identifying iris matchable components and corresponding coordinate data to the steering wheel controller 310.

FIG. 4 illustrates a computing system including a set of software components for providing a digital automobile steering wheel according to the present invention. The set of software components 401-409 provides executable instructions that may be executed by a programmable processing device. The set of software components 401-409 includes a steering wheel control 401, a user interface 402, an Iris Reader interface 403, a FaceID Reader interface 404, a Fingerprint Reader interface 405, a matchable components and corresponding coordinate data matcher 406, an interior light control 407, an environmental temperature control 408, an audio system control 409, and local data storage 410. The set of software components 401-409 works together to implement the functions of the digital steering wheel 100.

The steering wheel control 401 provides a user application level set of instructions that are executed to control the operation of the digital steering wheel 100. The steering wheel control 401 interacts with each of the software components 402-410 to cause the digital steering wheel 100 to operate as disclosed herein.

The user interface 402 provides input and output processing to provide a driver with messages and data needed to perform the digital steering wheel functions. This user interface module 402 also accepts commands from the driver to instruct the steering wheel control 301 to perform these tasks.

The Iris Reader interface 403 provides input and output processing to the steering wheel control 401 with iris scan data, iris matchable components and corresponding coordinate data, or iris image scan results needed to perform the driver identification and authorization functions. The Iris Reader interface 403 also sends commands from the steering wheel control 401 to initiate an iris scan.

The FaceID Reader interface 404 provides input and output processing to the steering wheel control 401 with face image data, iris matchable components and corresponding coordinate data, or FaceID image scan results needed to perform the driver identification and authorization functions. The FaceID Reader interface 404 also sends commands from the steering wheel control 401 to initiate FaceID image capture and processing.

The Fingerprint Reader interface 405 provides input and output processing to the steering wheel control 401 with fingerprint scan data, fingerprint matchable components and corresponding coordinate data, or fingerprint image scan results needed to perform the driver identification and authorization functions. The Fingerprint Reader interface 405 also sends commands from the steering wheel control 401 to initiate a fingerprint scan.

The interior light control 407 provides input and output processing to a steering wheel control 401 to provide a mechanism to activate and turn off vehicle interior lighting upon request by a driver. The steering wheel control 401 transmits a lighting command that indicates which particular interior light component is to be activated and an intensity level for the particular interior light component. The interior light control 407 processes the lighting command to send a control signal to a particular lighting component specified in the lighting command to implement the driver's request. The lighting command may comprise one or more lighting adjustment commands, each of which changes an operating condition of a separate lighting component, to permit the lighting command to alter multiple lighting components at one time.

The environmental temperature control 408 provides input and output processing to the steering wheel control 401 to provide a mechanism to activate and turn off vehicle heating and air conditioning systems upon request by a driver. The steering wheel control 401 transmits a temperature command that indicates which particular heating/air conditioning component is to be activated and a temperature level for use by the particular heating/air conditioning component. The environmental temperature control 407 processes the temperature command to send a control signal to a particular heating/air conditioning specified in the environmental command to implement the driver's request. The temperature command may comprise one or more temperature adjustment commands, each of which changes an operating condition of a separate heating/air conditioning component, to permit the temperature command to alter multiple heating/air conditioning components at one time. The separate heating/air conditioning component may include multiple zone heating and air conditioning controls within the vehicle 102.

The audio system control 409 provides input and output processing to the steering wheel control 401 to provide a mechanism to activate and turn off a vehicle audio system upon request by a driver. The steering wheel control 401 transmits an audio system command that indicates which particular audio system control component is to be activated and an intensity level for the particular audio system control component. The audio system control 409 processes the audio system control command to send a control signal to a particular audio system component specified in the audio system control command to implement the driver's request. The audio system control command may comprise one or more audio system control adjustment commands, each of which changes an operating condition of a separate audio system component, to permit the audio system control command to alter multiple audio system components at one time.

The local data storage 410 provides permanent data storage within the steering wheel controller 310 and the set of software components 401-409 described herein. The set of software components 401-409 may store and retrieve data from the local data storage 410, as needed, in order to perform its operations.

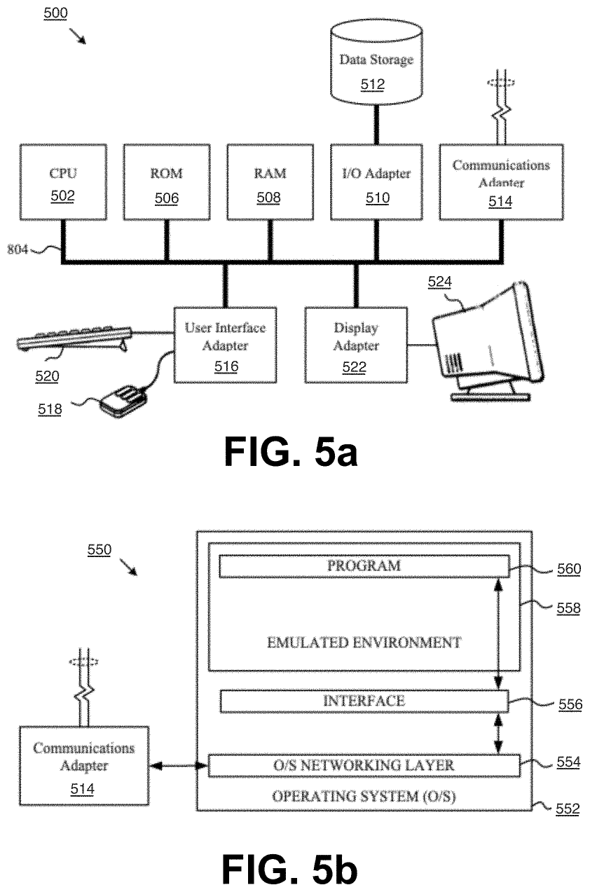

FIGS. 5a-b illustrate generalized schematics of a programmable processing system utilized as the various computing components described herein used to implement an embodiment of the present invention. FIG. 5a illustrates a computer system 500 adapted according to certain embodiments of the server and/or the user interface device. The central processing unit (“CPU”) 502 is coupled to the system bus 504. The CPU 502 may be a general purpose CPU or microprocessor, graphics processing unit (“GPU”), and/or microcontroller. The present embodiments are not restricted by the architecture of the CPU 502 so long as the CPU 502, whether directly or indirectly, supports the operations as described herein. The CPU 502 may execute the various logical instructions according to the present embodiments.

The computer system 500 also may include random access memory (RAM) 508, which may be synchronous RAM (SRAM), dynamic RAM (DRAM), synchronous dynamic RAM (SDRAM), or the like. The computer system 500 may utilize RAM 808 to store the various data structures used by a software application. The computer system 500 also may include read only memory (ROM) 506 which may be PROM, EPROM, EEPROM, optical storage, or the like. The ROM may store configuration information for booting the computer system 500. The RAM 508 and the ROM 506 hold user and system data, and both the RAM 508 and the ROM 506 may be randomly accessed.

The computer system 500 also may include an input/output (I/O) adapter 510, a communications adapter 514, a user interface adapter 516, and a display adapter 522. The I/O adapter 510 and/or the user interface adapter 516 may, in certain embodiments, enable a user to interact with the computer system 500. In a further embodiment, the display adapter 522 may display a graphical user interface (GUI) associated with a software or web-based application on a display device 524, such as a monitor or touch screen.

The I/O adapter 510 may couple one or more storage devices 512, such as one or more of a hard drive, a solid state storage device, a flash drive, a compact disc (CD) drive, a floppy disk drive, and a tape drive, to the computer system 500. According to one embodiment, the data storage 512 may be a separate server coupled to the computer system 500 through a network connection to the I/O adapter 510. The communications adapter 514 may be adapted to couple the computer system 500 to the network 508, which may be one or more of a LAN, WAN, and/or the Internet. The communications adapter 514 also may be adapted to couple the computer system 500 to other networks such as a global positioning system (GPS) or a Bluetooth network. The user interface adapter 516 couples user input devices, such as a keyboard 520, a pointing device 518, and/or a touch screen (not shown) to the computer system 500. The keyboard 520 may be an on-screen keyboard displayed on a touch panel. Additional devices (not shown) such as a camera, microphone, video camera, accelerometer, compass, and or gyroscope may be coupled to the user interface adapter 516. The display adapter 522 may be driven by the CPU 502 to control the display on the display device 524. Any of the devices 502-522 may be physical and/or logical.

The applications of the present disclosure are not limited to the architecture of a computer system 500. Rather the computer system 500 is provided as an example of one type of computing device that may be adapted to perform the functions of a steering wheel controller 310 and/or the user interface device 111. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, state machine digital logic-based circuitry, or other circuitry.

The embodiments described herein are implemented as logical operations performed by a computer. The logical operations of these various embodiments of the present invention are implemented (1) as a sequence of computer implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules. As such, persons of ordinary skill in the art may utilize any number of suitable electronic devices and similar structures capable of executing a sequence of logical operations according to the described embodiments. For example, the computer system 800 may be virtualized for access by multiple users and/or applications.

FIG. 5b is a block diagram illustrating a server hosting an emulated software environment for virtualization according to one embodiment of the disclosure. An operating system 552 executing on a server includes drivers for accessing hardware components, such as a networking layer 554 for accessing the communications adapter 514. The operating system 552 may be, for example, Linux. An emulated environment 558 in the operating system 552 executes a program 910, such as MacOS™, Windows™, and Linux™ running within a virtualized computing environment such as one provided by Parallels™. The program 560 accesses the networking layer 554 of the operating system 552 through a non-emulated interface 556, such as XNIOP. The non-emulated interface 556 translates requests from the program 960 executing in the emulated environment 558 for the networking layer 554 of the operating system 552.

If implemented in firmware and/or software, the functions described above may be stored as one or more instructions or codes on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc include compact discs (CD), laser discs, optical discs, digital versatile discs (DVD), floppy disks and Blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Even though particular combinations of features are recited in the present application, these combinations are not intended to limit the disclosure of the invention. In fact, many of these features may be combined in ways not specifically recited in this application. In other words, any of the features mentioned in this application may be included in this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

What is claimed is:

1. An article of manufacture providing a digital automobile steering wheel, the digital automobile steering wheel comprises:
a rotating steering wheel for providing directional for directing a vehicle when in motion;
a video display device coupled to a center of the rotating steering wheel configured to be visible to a driver when operating the rotating steering wheel;
a camera for obtaining an image of a face of the driver;
a fingerprint scanner for obtaining a fingerprint scan of a finger of the driver; and
an iris scanner for obtaining an iris scan of an eye of the driver.

2. The digital automobile steering wheel according to claim 1, wherein the digital automobile steering wheel further comprises:
a set of control electronics and processing components;
a position communications device for providing a current position of the steering wheel; and
a user interface port coupled to one or more steering wheel user input/output devices for receiving input from the driver.

3. The digital automobile steering wheel according to claim 2, wherein the set of control electronics and processing components comprises:
a steering wheel controller;
a steering wheel connection;
a rotation resistance controller;
the user interface port that is coupled to the one or more steering wheel user input/output devices;
a FaceID reader coupled to the camera;
a fingerprint reader coupled to the fingerprint scanner; and
an iris reader coupled to the iris scanner.

4. The digital automobile steering wheel according to claim 2, wherein the rotating steering wheel comprising:
an inner portion;
an outer portion coupled to an outer edge of the inner portion, the inner portion rotates about the outer edge; and
the position communications device configured between the outer portion and inner portion.

5. The digital automobile steering wheel according to claim 4, wherein the position communications device utilizes two or more optical sensors for detecting the passage of equally spaced position markings as the outer portion rotates about the inner portion.

6. The digital automobile steering wheel according to claim 4, wherein the position communications device utilizes two or more electrical connections for detecting the passage of equally spaced position electrical connections as the outer portion rotates about the inner portion.

7. The digital automobile steering wheel according to claim 4, wherein the rotating steering wheel is removable for utilizing different diameter wheels.

8. The digital automobile steering wheel according to claim 4, wherein the video display device continually presents an upright image as the rotating steering wheel rotates.

9. The digital automobile steering wheel according to claim 3, wherein the rotation resistance controller generates rotational resistance commands based upon a current position of the rotating steering wheel from the position communications device and haptic data commands from the steering wheel controller as the vehicle is being driven.

10. The digital automobile steering wheel according to claim 3, wherein the rotational resistance commands generated by the rotation resistance controller are transmitted to the rotating steering wheel over the steering wheel connection for adjusting an amount of rotational resistance should be applied by the rotating steering wheel to adjust the ease at which the driver may rotate the rotating steering wheel.
